(19) United States
(12) Patent Application Publication
(10) Pub. No.: US 2016/0318790 A1
(43) Pub. Date: Nov. 3, 2016

(54) METHOD AND SYSTEM FOR SCRIBING HEAT PROCESSED TRANSPARENT MATERIALS

(71) Applicant: ROFIN-SINAR TECHNOLOGIES INC., PLYMOUTH, MI (US)

(72) Inventors: S. ABBAS HOSSEINI, ORLANDO, FL (US); ROLAND MAYERHOFER, Roettenbach (DE)

(73) Assignee: ROFIN-SINAR TECHNOLOGIES INC., PLYMOUTH, MI (US)

(21) Appl. No.: 14/700,228

(22) Filed: Apr. 30, 2015

(51) Int. Cl. C03B 27/012; C03C 23/00; C03B 33/02; C03C 3/00

(52) U.S. Cl. CPC C03B 27/012; C03C 3/00; C03C 23/0025; C03B 33/0222

(57) ABSTRACT

A method of laser processing a heat processed transparent material is disclosed wherein the heat processed transparent material includes a top compressive layer, a bottom compressive layer, and a tensile layer between the top compressive layer and the bottom compressive layer. A laser beam includes a burst of laser pulses or a single laser pulse which is externally focussed relative to the heat processed transparent material to form a beam waist at a first location external to the heat processed transparent material avoiding formation of a plasma channel external to the heat processed transparent material. The laser pulses or pulse are focused such that a sufficient energy density is maintained within the bottom compressive layer of the heat processed transparent material to form continuous laser filaments in the top and bottom compressive layers therein without causing optical breakdown. The laser filaments do not extend into the tensile layer.

U.S. patent application Ser. No. 13/640,140, filed Jan. 31, 2013, U.S. patent application Ser. No. 14/336,912, filed Jul. 21, 2014, U.S. patent application Ser. No. 14/336,819, filed Jul. 21, 2014, U.S. patent application Ser. No. 13/958,346 filed Aug. 2, 2013, and U.S. patent application Ser. No. 14/629,327 filed Feb. 23, 2015 are hereby incorporated herein by reference hereto as if fully written herein.

### BACKGROUND OF THE INVENTION

The present disclosure is related to systems and methods for the laser processing of materials. More particularly, the present disclosure is related to systems and methods for the singulation and/or cleaving of tempered and heat strengthened glass. Tempered and heat strengthened glass is said to be heat processed.

While heat processed (tempered and heat strengthened) transparent materials such as glass have wide usage in transportation vehicles, architectural windows and doors, appliances, anti-vandalism cover glass, the major drawback is the glass up to now cannot be cut to size after it has been heat processed. The standard manufacturing sequence is to cut the glass in a non-heat processed state and conduct the strengthening process afterwards. By applying classic surface scribing technology to heat processed glass, the internal stress will be released immediately in an uncontrolled manner, causing the glass plate to explode into a myriad of small pieces. It is, therefore, necessary to understand the internal stress distribution in heat processed glass to design a structure and process to cut heat processed glass in the required size.

In the diamond cutting process, after diamond cutting is performed, a mechanical roller applies stress to propagate cracks that cleave the sample. This process creates poor quality edges, microcracks, wide kerf width, and substantial debris that are major disadvantages in the lifetime, efficiency, quality, and reliability of the product, while also incurring additional grinding, cleaning and polishing steps. The cost of de-ionized water to run the diamond scribers is more than the cost of ownership of the scriber, and the technique is not environmentally friendly since water is contaminated by the process and requires refining, which further adds to the production cost.

Laser ablative machining has been developed for singulation, dicing, scribing, cleaving, cutting, and facet treatment, to overcome some of the limitations associated with diamond cutting. Unfortunately, known laser processing methods have disadvantages, particularly in transparent materials, such as slow processing speed, generation of cracks, contamination by ablation debris, and moderated sized kerf width. Furthermore, thermal transport during the laser interaction can lead to large regions of collateral thermal damage (i.e. heat affected zone).

Laser ablation processes can be improved by selecting lasers with wavelengths that are strongly absorbed by the medium (for example, deep UV excimer lasers or far-infrared CO₂ laser). However, the aforementioned disadvantages cannot be eliminated due to the aggressive interactions inherent in this physical ablation process. This is amply demonstrated by the failings of UV processing in certain LED applications where damage has driven the industry to focus on traditional scribe and break followed by etching to remove the damaged zones left over from the ablative scribe or the diamond scribe tool, depending upon the particular work-around technology employed.

Alternatively, laser ablation can also be improved at the surface of transparent media by reducing the duration of the laser pulse. This is especially advantageous for lasers that are transparent inside the processing medium. When focused onto or inside transparent materials, the high laser intensity induces nonlinear absorption effects to provide a dynamic opacity that can be controlled to accurately deposit appropriate laser energy into a small volume of the material as defined by the focal volume. The short duration of the pulse offers several further advantages over longer duration laser pulses such as eliminating plasma creation and therefor plasma reflections thereby reducing collateral damage through the small component of thermal diffusion and other heat transport effects during the much shorter time scale of such laser pulses.

Femtosecond and picosecond laser ablation, therefore, offer significant benefits in machining of both opaque and transparent materials. However, in general, the machining of transparent materials with pulses even as short as tens to hundreds of femtoseconds is also associated with the formation of rough surfaces, slow throughput and micro-cracks in the vicinity of laser-formed kerf, hole or trench that is especially problematic for brittle materials like alumina (Al₂O₃), glasses, doped dielectrics and optical crystals. Further, ablation debris will contaminate the nearby sample and surrounding devices and surfaces. Recently, multi-pass femtosecond cutting has been discussed in Japan, utilizing a fiber laser approach. This approach suffers from the need to make multiple passes and therefore results in low processing throughput.

Although laser processing has been successful in overcoming many of the limitations, water jets are also used in most companies dealing with glass for their manufacturing. Very high pressure water that has some mixture of abrasive material exits from a nozzle and cuts the material leaving very rough surfaces, big chips and micro-cracks.

All aforementioned techniques have one problem in common, they cause micro-cracks or thermal stress inside the scribe line.

The process of manufacturing heat strengthened and tempered glass starts with heating the annealed glass from 550 to 900 degree C., then rapidly cooling takes place where both top and bottom surfaces are cooled down quickly. Due to the low heat conductivity of glass, the inner portion of the glass cools down at a lower cooling rate than the outer portion. This causes the creation of compressive tension at both surface regions, compensated by tensile stress in the middle inner layer. Strengthened glass bending stress test exceeds 70 MPa to be considered strengthened. In tempered glass the compressive stress exceeds 100 MPa. If glass is fully strengthened it is called tempered and generally it is much tougher than heat strengthened glass. Breaking these hardened glasses is difficult, but if tempered glass breaks it breaks in to smaller granular parts due to surface compression and middle tensile stress. For this unique property tempered glass sometimes is referred to as safety glass in high rise buildings since if it breaks for any reason, it explodes in to very tiny pieces. Auto manufacturing companies generally don't use tempered glass as windshields because in an accident glass can explode into smaller segments and blind the driver. Windshields comprise two layers of glass connected by a plastic transparent film in between. The plastic film holds the segments intact during accidents. When the windshield is heat strengthened it breaks into larger pieces. If the windshield breaks, the plastic film prevents glass from falling onto the driver. The rear glass and windows are generally fully tempered for safety reasons.

Therefore the main issue in cutting heat processed glass is the very sensitive tensile middle layer that explodes if any cracks or shock approach this region. Therefore, there is a need to cut heat processed glass cleanly such that it does not break when cut.

### SUMMARY OF THE INVENTION

Systems and methods are described for forming continuous laser filaments in transparent materials. A burst of ultrafast laser pulses is focused such that a beam waist is formed external to the material being processed, such that a primary focus does not form within the material, while a sufficient energy density is formed within an extended region within the material to support the formation of a continuous filament, without causing optical breakdown within the material. Filaments formed according to this method reside in the compressive stress layers. The filaments do not extend into the tensile stress layer. Filament formation is created by acoustic shock waves and if a filament enters the tensile stress layer it results in exploding the heat processed glass. The procedure is to create filament scribing in both compressive layers and avoid scribing the tensile layer. Due to internal stress build up, both filaments connect to each other via crack formation in the tensile layer causing separation of heat processed glass. The crack formation in the tensile layer occurs naturally.

In some embodiments, an uncorrected or aberrated optical focusing element is employed to produce an external beam waist while producing distributed focusing (elongated focus) of the incident beam within the material. Various systems are described that facilitate the formation of filament arrays within transparent substrates for cleaving/singulation and/or marking Optical monitoring of the filaments may be employed to provide feedback to facilitate active control of the process.

The present disclosure provides devices, systems and methods for the processing of orifices in transparent materials by laser induced photoacoustic compression. Unlike previously known methods of laser material machining, embodiments of the present invention utilize an optical configuration that focuses the incident beam in a three dimensional distributed manner along the longitudinal beam axis.

Accordingly, in a first aspect of the invention a double scan is used and there is provided a method of laser processing a heat processed transparent material, the heat processed transparent material includes a top compressive layer, a bottom compressive layer, and a tensile layer between the top compressive layer and the bottom compressive layer, comprising the steps of:

providing a laser beam, the laser beam includes a burst of ultrafast laser pulses or a single ultrafast laser pulse;

externally focusing the laser beam relative to the heat processed transparent material to form a beam waist at a first location external to the heat processed transparent material;

the laser pulses or pulse are focused such that a sufficient energy density is maintained within the bottom compressive layer of the heat processed transparent material to form a first continuous laser filament in the bottom compressive layer therein without causing optical breakdown;

the first filament is located in the bottom compressive layer and extends to an external surface of the bottom compressive layer, the first filament starting below the tensile layer;

externally focusing the laser beam relative to the heat processed transparent material to form a beam waist at a second location external to the heat processed transparent material;

the laser pulses or pulse are focused such that a sufficient energy density is maintained within the top compressive layer of the heat processed transparent material to form a second continuous laser filament in the top compressive layer therein without causing optical breakdown;

the second filament is located in the top compressive layer and extends to an external surface of the top compressive layer, the second filament starting above the tensile layer;

means for varying the relative position between the laser beam and the heat processed transparent material; and,

a control and processing unit operatively coupled to the means for varying the relative position between the laser beam and the transparent material, wherein the control and processing unit is configured to control the relative position between the laser beam and the transparent material for the formation of an array of continuous laser filaments within the transparent material.

In a second aspect of the invention using a single scan, a method of laser processing a heat processed transparent material, the heat processed transparent material includes a top compressive layer, a bottom compressive layer, and a tensile layer between the top compressive layer and the bottom compressive layer, comprising the steps of:

providing a laser beam, the laser beam includes a burst of ultrafast laser pulses or a single ultrafast laser pulse;

externally focusing the laser beam relative to the heat processed transparent material to form a beam waist at a first location external to the heat processed transparent material and, simultaneously, externally focusing the laser beam relative to the heat processed transparent material to form a beam waist at a second location external to the heat processed transparent material;

the laser pulses or pulse are focused such that a sufficient energy density is maintained within the bottom compressive layer of the heat processed transparent material to form a first continuous laser filament in the bottom compressive layer therein without causing optical breakdown and, the laser pulses or pulse are focused such that a sufficient energy density is maintained with the top compressive layer of the heat processed transparent material to form a second continuous laser filament in the top compressive layer therein without causing optical breakdown;

the first filament is located in the bottom compressive layer and extends to an external surface of the bottom compressive layer, the first filament starting below the tensile layer, and, the second filament is located in the top compressive layer and extends to an external surface of the top compressive layer, and, the second filament starting above the tensile layer; and,

means for varying the relative position between the laser beam and the heat processed transparent material.

Very fine closed form structures can be scribed via filamentation in the heat processed transparent substrate very quickly, the modified zone can be etched via dry or wet chemical etching to release the closed form.

A further understanding of the functional and advantageous aspects of the disclosure can be realized by reference to the following detailed description and drawings.

### BRIEF DESCRIPTION OF THE DRAWINGS

FIG. 1 illustrates optical configurations for the formation of filaments in which long homogeneous filaments are formed by focusing the beam energy such that it is “dumped” into a focus above and/or below the target material (forming an “optical reservoir”) in order to modulate the amount of energy passed into the desired filament zone.

FIG. 2 is a diagrammatic illustration of a substrate with scribed closed form where the closed form is the desired part.

FIG. 2A is an enlarged portion of FIG. 1 illustrating the spacing between orifices/holes.

FIG. 2B is a diagrammatic cross-sectional view taken along the lines of 2B-2B of FIG. 2A.

FIG. 2C is a diagrammatic cross-sectional view taken vertical to the line 2B-2B of FIG. 2A.

FIG. 2D is an enlargement of a portion of FIG. 2C.

FIG. 3 illustrates heat processed glass facet view.

FIG. 4A illustrates formation of filaments in the top and bottom compressive layers of the heat processed glass of FIG. 3.

FIG. 4B is a photograph of the top and bottom compressive layers and the middle tensile layer.

FIGS. 5A-5E illustrate the angled cut out approach for making angled edges.

FIGS. 6A-6C illustrate an example embodiment showing the formation of complex spline parts from curved targets by servoing the z and “steering the beam” via adaptive optics, which are also controlled by servoing.

FIG. 7 illustrates an embodiment for producing filaments that are suitable for substrate machining.

FIGS. 8A and 8B are top and front views illustrating the layout of an example laser system suitable for part scribing.

### DETAILED DESCRIPTION OF THE INVENTION

Embodiments of the disclosure will now be described, by way of example only, with reference to the drawings.

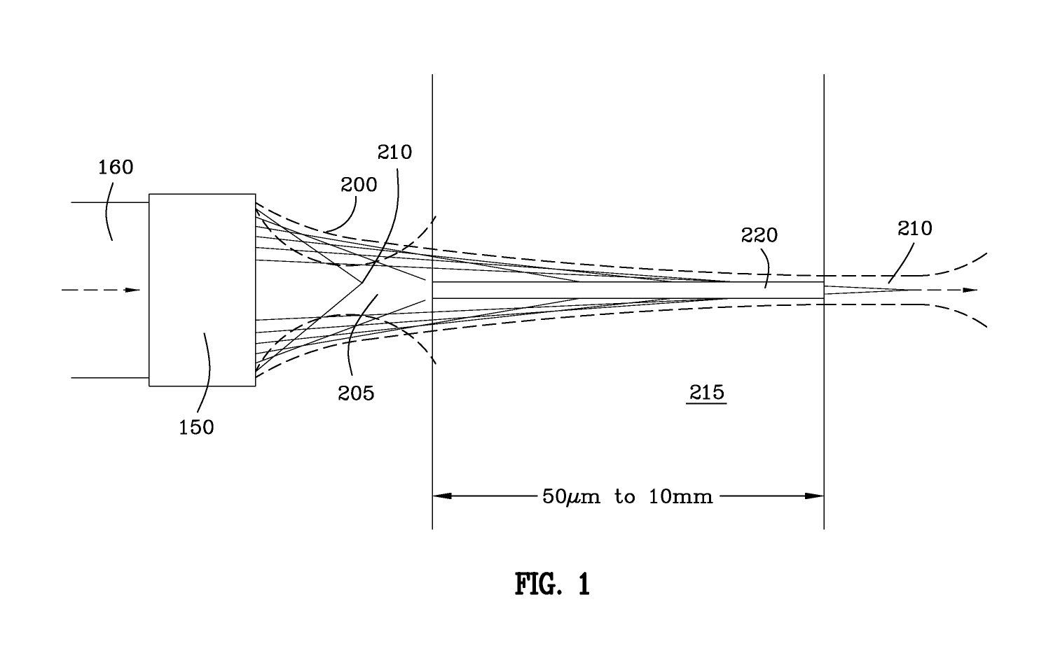

FIG. 1 illustrates optical configurations for the formation of filaments in annealed glass which long homogeneous filaments 220 are formed by focusing the beam energy such that it is “dumped” into a focus above and/or below the target material (forming an optical reservoir 205) in order to modulate the amount of energy passed into the desired filament zone. Incoming laser beam 160 passes through focus assembly 150 which creates foci above and/or below 210 the target substrate 215.

The propagation of ultrafast laser pulses in transparent optical media is complicated by the strong reshaping of the spatial and temporal profile of the laser pulse through a combined action of linear and nonlinear effects such as group-velocity dispersion (GVD), linear diffraction, self-phase modulation (SPM), self-focusing, multiphoton/tunnel ionization (MPI/TI) of electrons from the valence band to the conduction band, plasma defocusing, and self-steepening. See S. L. Chin et al. Canadian Journal of Physics, 83, 863-905 (2005). These effects play out to varying degrees that depend on the laser parameters, material nonlinear properties, and the focusing condition into the material. Due to the dependence of nonlinear refractive index to intensity, during the propagation of intense laser pulses, the central part of the pulse moves slower than the surrounding parts of the pulse due to variable refractive index that causes the pulse to self-focus. In the self-focusing region due to MPI/TI plasma generated, plasma acts as a negative lens and defocuses the pulse but due to high intensity self-focusing occurs again. The balancing act between focusing and defocusing creates a long plasma channel that is known as a filament. Using a low per pulse energy filament leaves traces of refractive index modification in the material. The filament is surrounded by background energy that pumps energy to form the filament. This background energy is known as a filament reservoir. Blocking or disturbing a portion of reservoir will have the effect of losing the filament. For this reason the space separation between the filaments is crucial for filament formation. Otherwise damages and cracks form in the substrate instead of scribing. During filament formation the photoacoustic effect takes place which inherently generates plasma. During filamentation, confined holes having a diameter of 1 μm or less are opened in the substrate and, depending on the laser input power, can reach up to 10 mm long without changing the diameter. For this reason it is possible to stack many sheets of flat substrates and scribe all of them in a single motion. Filaments can form using a single pulse ultrafast laser inside the material as far as higher than critical peak power for that specified material is used. Using multiple pulses as a train of pulses or a burst of pulses produces better filament formation due to heat accumulation and consecutive photoacoustic shock wave generation.

Optical break down is the consequence of a tight focus inside the material (plasma void forms and laser focuses). In linear optics it is possible to achieve a 1 μm diameter spot size by using a NA (numerical aperture) of 1 or higher (100× objective oil immersed) for 1 μm wavelength beam but the beam diverges immediately after the focus. Using high power pulses a plasma spark will generated in the focus which is known as optical break down. Filament formation is the result of very mild focus using a NA (numerical aperture) of less than 0.4 where the focusing element assists in the formation of filament. While geometrical focus might have a 100 to 200 μm spot size on the surface of the target, the pulses self-focus themselves to 1 μm diameter. While filament or plasma channel is the standard description for this process, it is also known as an elongated focus. The term elongated focus is used to describe the same effect of using ultrafast pulses. It is impossible to elongate long laser pulses and observe the same effect.

Furthermore, the heat accumulation effect would disappear if burst frequency of 1 MHz or lower is used while heat accumulation works very well to produce well pronounced filaments from 30 to 60 MHz burst frequency. At this condition a narrow crack less than 100 nm wide forms from filament to filament. This creates a curtain or crack wall all the way from top to bottom of the sample along the scribe line. Applying leak detector dye proved that dye can pass through the scribe line and end up in another surface. The capillary effect enables dye to travel all the way inside the crack curtain and filament channels.

While we disclose use of a 30 MHz seeder StarPico model, 30 MHz is our standard burst frequency and single or multiple pulses as a burst can be picked at 100 kHz frequency for further amplification to reach 50 W average power at less than 15 ps (picosecond, pulse duration). Output is 1-6 pulses in the burst envelope exceeding critical power to make filaments in the glass substrate.

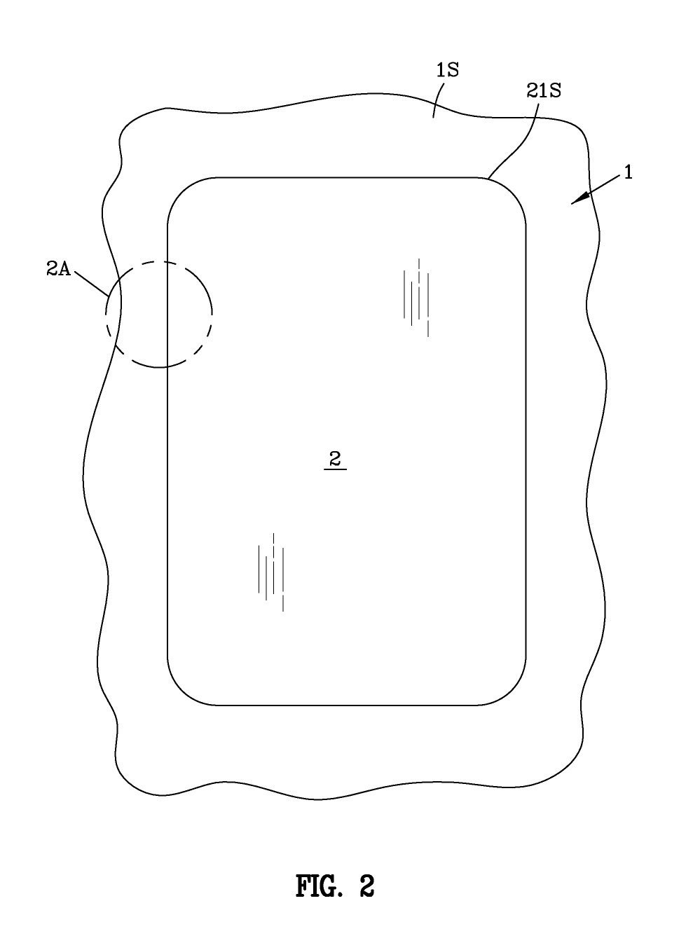

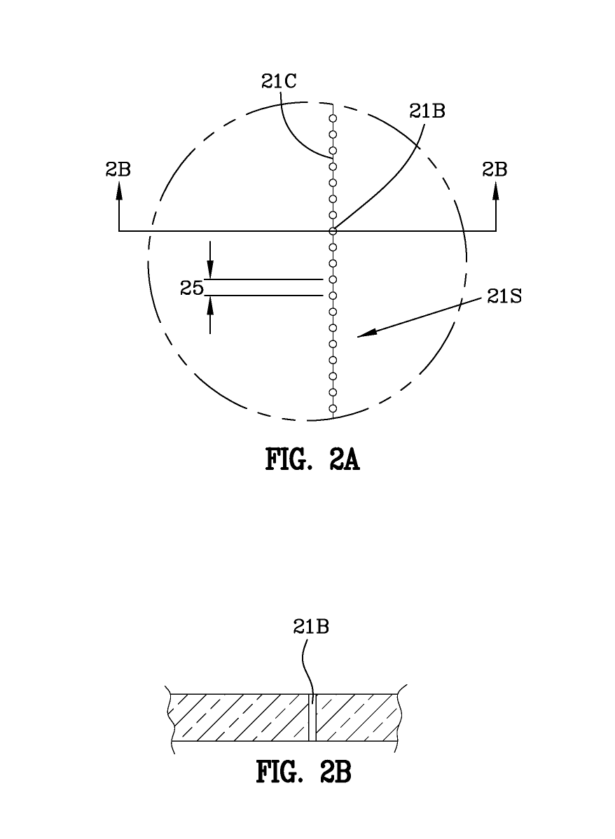

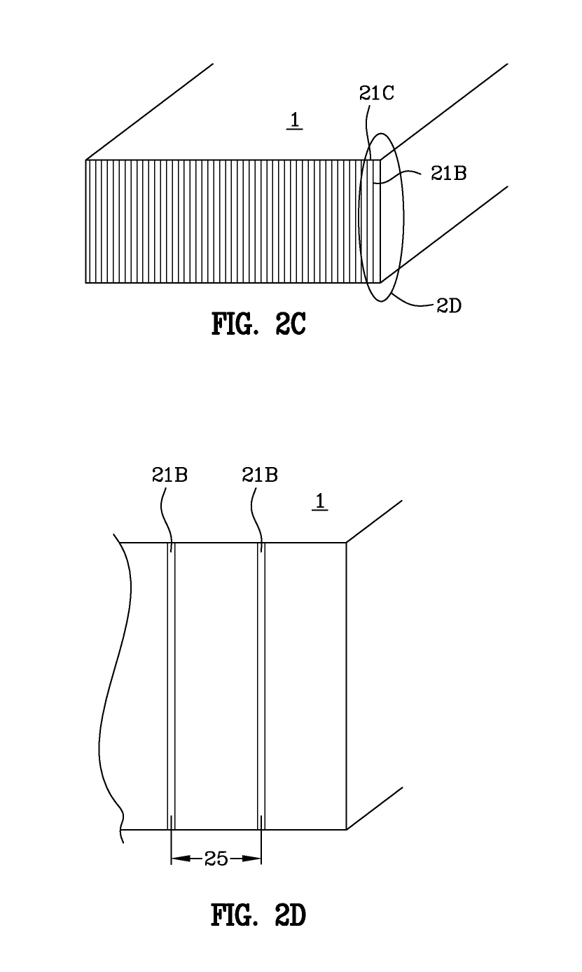

FIG. 2 is a diagrammatic illustration of a non heat-processed substrate with scribed closed form where the closed form is the desired part. The closed form (desired part) is the part in the middle of FIG. 2 denoted by reference numeral 2.

There are clearly two strategies when the main body or closed form is the desired part. As shown in FIG. 2, product 2 is the closed form that is the desired part formed via filamentation scribing on the main substrate 1. Referring to FIG. 2, solid line 21S represents the scribed line which is cut into the surface 1S of the substrate 1. As an example closed form can be but is not limited to a smartphone cover glass or auto windshield, mirrors, architectural windows, etc.

FIG. 2A is an enlarged portion of FIG. 2 illustrating the spacing between holes (orifices) 21B. Orifices 21B are approximately 1 μm in diameter. Microcracks 21C are illustrated between the orifices 21B in FIG. 2A. Microcracks 21C are created by a shock wave due to photoacoustic compression. The spacing between the holes (orifices) is 2-10 μm center to center as illustrated by reference numeral 25 depending on the type of form (sample type), substrate thickness and orifice depth.

FIG. 2B is a diagrammatic cross-sectional view taken along the lines of 2B-2B of FIG. 2A. Orifice 21B extends completely through the substrate. All of the orifices drilled in the transparent substrate are substantially cylindrically shaped with no taper. Desired closed form can be released via a different technique such as weakening the cut region by resting the sample in water for OH exchange, heating, cooling, or air pressure. FIG. 2C is a perspective view of the cut after the sample is cleaved. Evenly spaced filaments, parallel to each other, are observable.

FIG. 2D is an enlargement of a portion of FIG. 2C illustrating the substrate after it has been cut. FIG. 2C illustrates orifices 21B after being cut (cleaved) along the microcracks 21C.

FIG. 3 schematically illustrates the heat processed glass 30. FIG. 3 illustrates the middle layer 31L under tensile stress while both the top and bottom layers 32L, 32L are under compressive stress 32. While scribing this glass any crack formation in the tensile layer using a diamond scriber or roller, laser ablation or even laser filamentation can cause the heat processed glass 30 to explode because they interact with the tensile layer 31L.

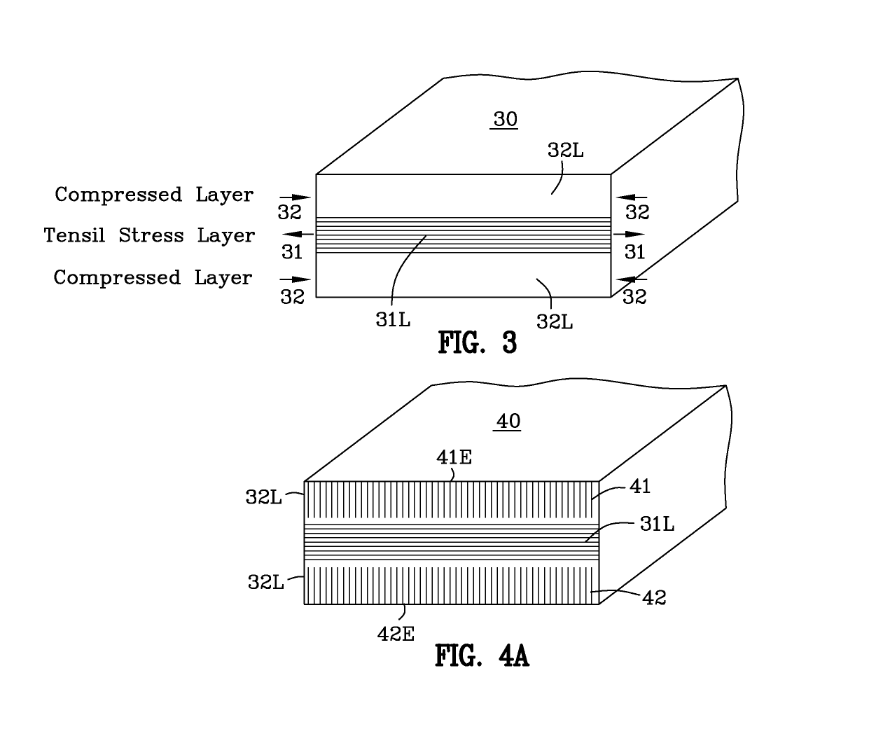

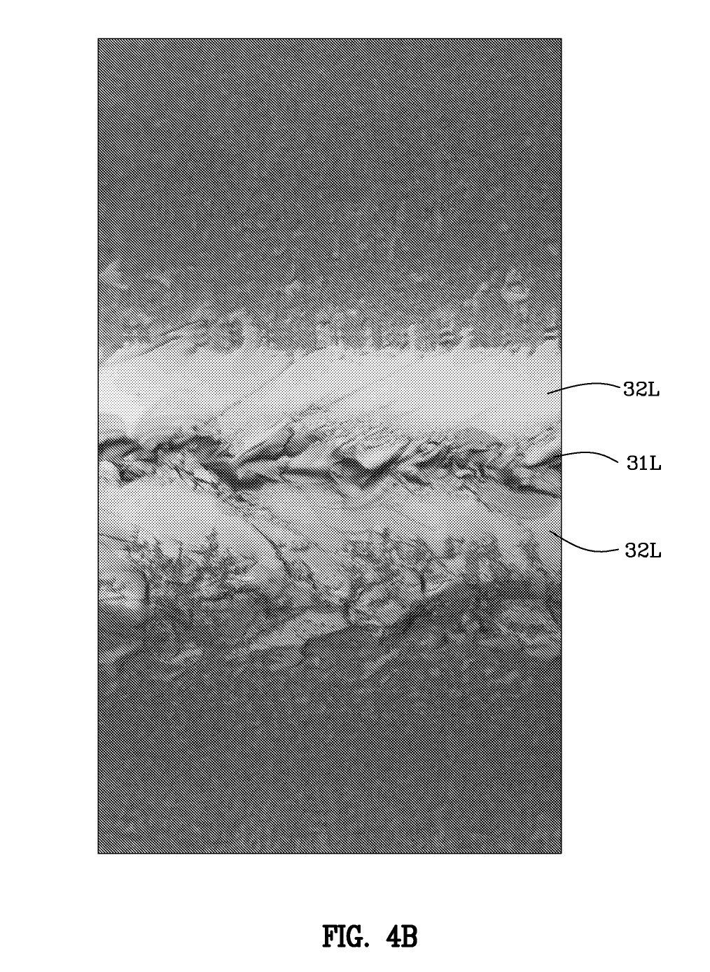

FIG. 4A illustrates filamentation of heat processed glass according to the invention. Filaments 41, 42 are formed in the compressive layers 32L, 32L but do not extend too close to the tensile layer 31L. One scan forms the filaments 42 in the bottom layer 32L and another scan forms the filaments 41 in the top layer 32L. The filaments 42 extend inwardly from the bottom edge 42E. The filaments 41 extend inwardly from the top edge 41E. Due to well localized pressure both filaments 41, 42 connect via natural crack formation through the tensile layer 31L without exploding the glass in the layers 32L, 32L and 31L. Samples cut using this technique were observed for weeks and remained stable. Filaments 41, 42 can be created using a single scan or a double scan.

Optionally, a subsequent facet treatment after tempered (strengthened) glass separation will prevent any future crack formation. Compressive layers 32L, 32L can be ground, polished, and heat treated.

Localized heat only heats the facet, and by cooling the sample quickly the facet hardens. Another possible post-treatment would be to apply chemical paste to the facet, causing chemical strengthening of the facet by ion exchange.

FIG. 4B is a photograph of the top and bottom compressive layers 32L, 32L and the middle tensile layer 31L.

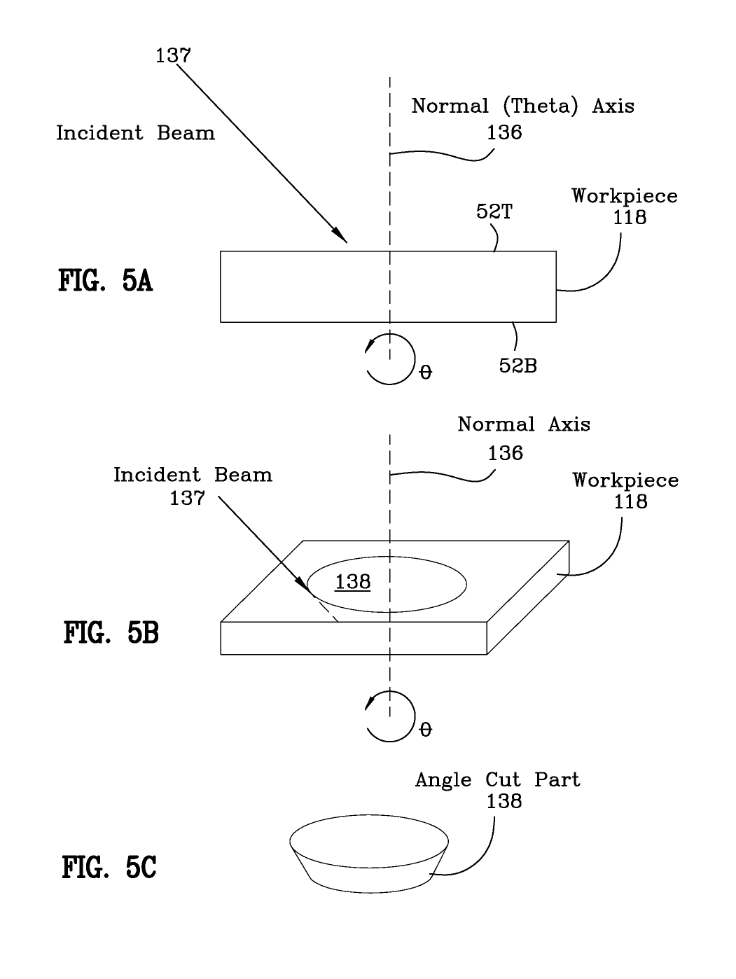

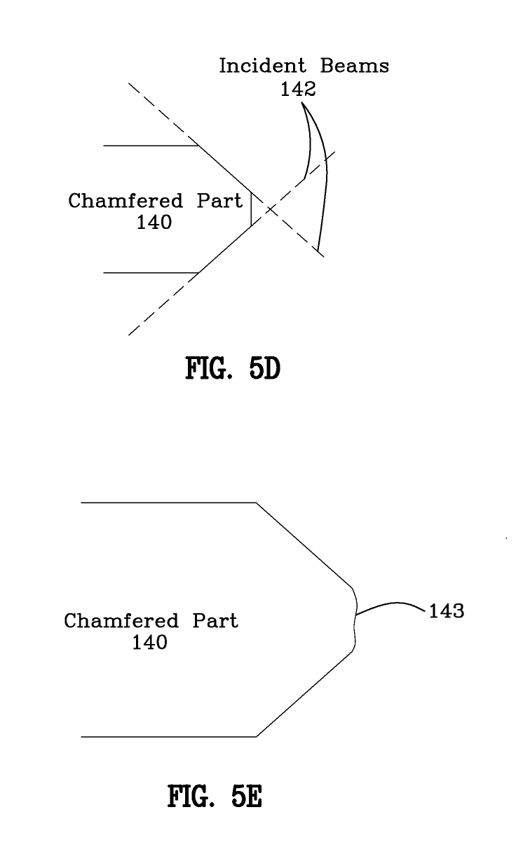

FIGS. 5A-E show an angled cut-out approach for making internal features with angled edges, without requiring post singulation processing to achieve the desired angular result. In FIGS. 5A-E, the beam tracks 137, 142 are accomplished via rotation around the theta axis 136 with a fixed incidence angle from the laser beam, equal to the slope desired on the final part edge 138. The process can be done in two steps, where in the first rotation the bottom compressive layer 52B is scribed and in the second rotation the top compressive layer 52T is scribed. This non-limiting embodiment enables angled cutting and translation of the rotary stage as an apparatus to support the creation of complex cutouts via filament arrays.

FIGS. 5D and 5E illustrates an example implementation of the formation of a chamfered part 140 via processing with multiple filament forming beams 142 at different angles. The beam and filament paths can be controlled to form chamfered or beveled edges of various degrees. In the case of concerted (parallel) formation, the beam can be split and directed through optics to achieve multiple beam paths arriving at the target exhibiting angles of incidence other than normal to form a scribed line in both top and bottom compressive layers (52T, 52B). The glass will separated via self-cleaving (done naturally) through the tensile layer such that a three-face edge or chamfer is created. Self-cleaving of the chamfered part is illustrated in FIG. 5E wherein the vertical cut 143 may be somewhat rough.

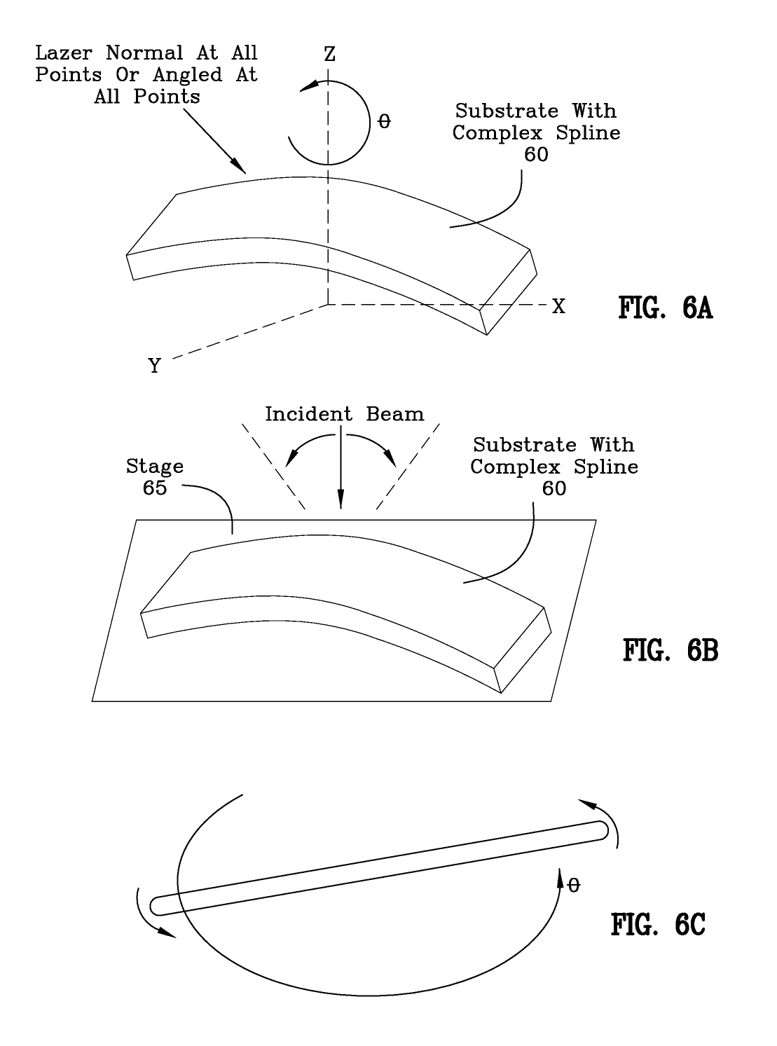

FIGS. 6A and 6B illustrate the processing of samples with a complex spline surface 60, from which parts may be cut of arbitrary shape with normal or non-normal beam incidence across the entire perimeter of the part shape as dictated by the desired characteristics of the part thus singulated (e.g. strength, conductivity, electrical efficiency of devices therein/thereon, etch resistance or efficacy, etc.). Coordinated motion in the theta and gamma axes with appropriate translation in the XY plane coupled with auto focus for constant objective lens spacing, can be employed to generate parts with user-selectable (over a reasonable range) properties depending upon the application of the part and its required/desired performance envelope. The optics (FIG. 6A) and/or the part (FIG. 6B) being processed may be translated and/or rotated to achieve this capability. FIGS. 6B and 6C illustrate the translation and/or rotation of the part being processed via a stage 65.

FIGS. 6A-6C illustrate an example embodiment showing the formation of complex spline parts from curved targets by servoing the z and “steering the beam” via adaptive optics, which are also controlled by servoing. The beam (FIG. 6A) and/or part (FIGS. 6B and 6C) can be rotated, tilted or otherwise manipulated to create a very wide process window and capability for producing parts with complex surface curvature.

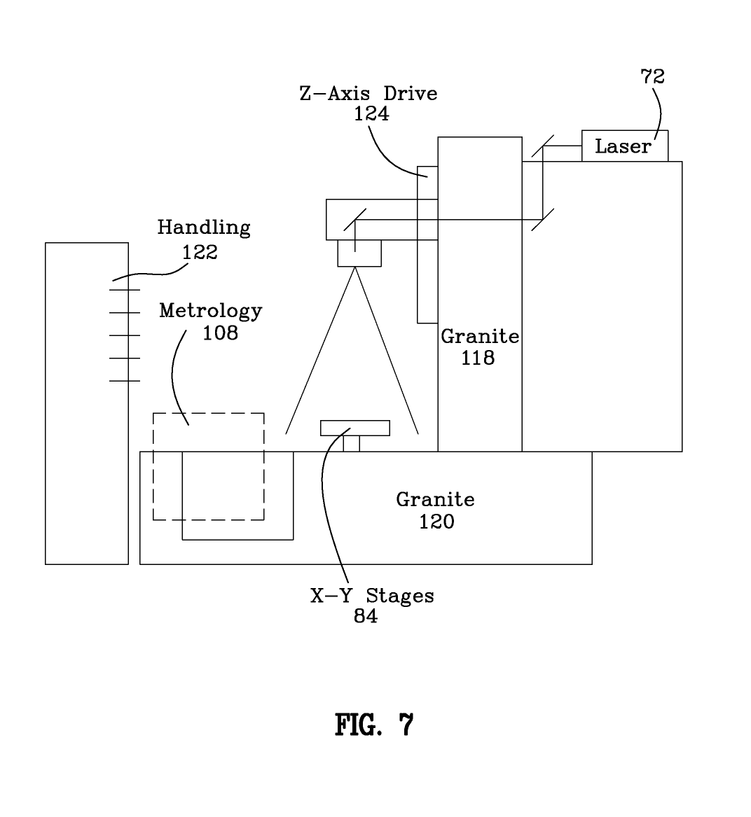

FIG. 7 illustrates the layout of an example laser system suitable for part singulation. Laser 72 is capable of delivering burst pulses, for example, with energies in the range of approximately 1 μJ-50 mJ, at a repetition rate of up to approximately 2.5 MHz.

Granite riser 118 is designed to be a reactive mass for dampening mechanical vibrations, as is commonly used in industry. This could be a bridge on which the optics above the stage can translate along one axis, X or Y relative to the stage, and in coordination with it. Granite base 120 provides a reactive mass that may support any or all components of system. In some embodiments, handling apparatus 122 is vibrationally decoupled from the system for stability reasons.

Z axis motor drive 124 is provided for translating the optics (conditioning and focusing and scan optics if needed) in the Z axis relative to the servo controlled X-Y stage 84. This motion can be coordinated with the XY stage 84 and X or Y motion in the overhead granite bridge, and the XY motion of the stage on the granite base 120, which holds the sample material to be processed.

Stage 84 includes, for example, XY and Theta stages with a tilt axis, gamma (“yaw”). The motion of stages 84 is coordinated by a control computing system, for example, to create a part shape desired from a larger mother sheet. Metrology device 108 provides post processing or preprocessing (or both) measurements, for example, for mapping, sizing, and/or checking edge quality post cut.

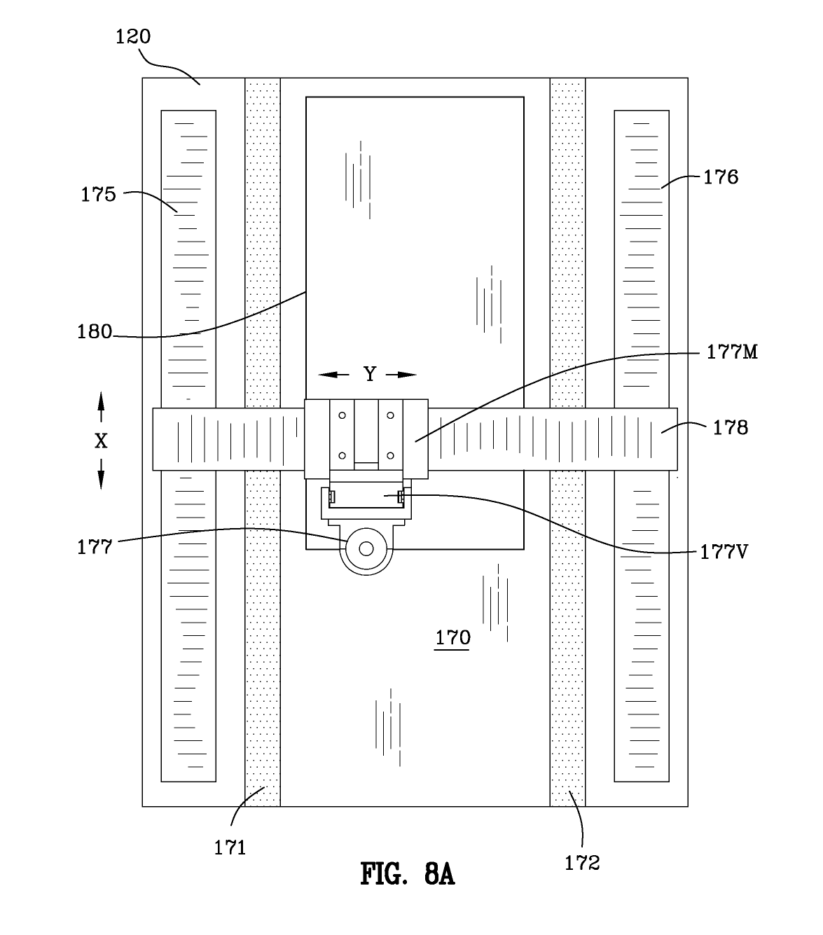

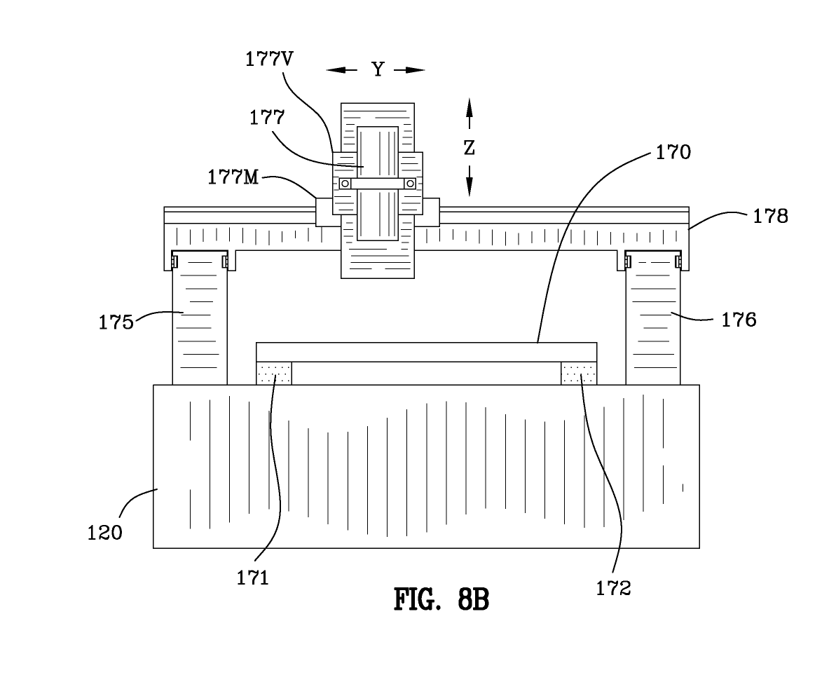

FIG. 8A is a schematic top view of an example laser system for cutting architectural glass using laser machining X-Y motion of the laser head 177 is illustrated in FIG. 8A wherein the laser head 177 is illustrated schematically above glass substrate 170. The scribed line 180 can be created using a single scan or a double scan and defines a closed form within the scribed line. Scribed line 180 includes filaments 41, 42 as illustrated in FIG. 4A. Glass substrate 170 is supported by beams 171, 172 above a granite (or other dimensionally stable) support 120. Rails 175, 176 support the movable arm 178 which is movable in the X direction along the rails 175, 176 as illustrated in FIG. 8A. Movable arm 178 is driven by a motor and a controller which precisely positions the movable arm 178 in the X direction. Similarly, the laser head is driven by a motor and a controller and is precisely movable and positioned along the movable arm 178 in the Y direction as illustrated in FIGS. 8A and 8B. FIG. 8 B is a schematic side view of the example laser system for cutting an architectural glass window. The same structure and techniques illustrated in FIGS. 8A and 8B can be used for cutting a windshield or other structure.

Movable arm 178 includes rail means and the laser head 177 includes a motor 177M or other means for positioning the laser head 177 in the Y direction. Further the laser head is movable in the Z direction for adjusting the beam waists as desired. Vertical rail 177V enables movement of the laser head 177 in the vertical direction (the Z direction). Still further, it is understood that a selected distributive-focus lens may be adapted for use with the laser head 177.

The invention has been set forth by way of example and those skilled in the art will recognize that changes may be made to the invention as disclosed herein without departing from the spirit and scope of the claims which follow hereinafter.

1. A method of laser processing a heat processed transparent material, said heat processed transparent material includes a top compressive layer, a bottom compressive layer, and a tensile layer between said top compressive layer and said bottom compressive layer, comprising the steps of:
providing a laser beam, said laser beam includes a burst of ultrafast laser pulses or a single ultrafast laser pulse;
externally focusing said laser beam relative to said heat processed transparent material to form a beam waist at a first location external to said heat processed transparent material;
said laser pulses or pulse are focused such that a sufficient energy density is maintained within said bottom compressive layer of said heat processed transparent material to form a first continuous laser filament in said bottom compressive layer therein without causing optical breakdown;
said first filament is located in said bottom compressive layer and extends to an external surface of said bottom compressive layer, said first filament starting below said tensile layer;
externally focusing said laser beam relative to said heat processed transparent material to form a beam waist at a second location external to said heat processed transparent material;
said laser pulses or pulse are focused such that a sufficient energy density is maintained within said top compressive layer of said heat processed transparent material to form a second continuous laser filament in said top compressive layer therein without causing optical breakdown;
said second filament is located in said top compressive layer and extends to an external surface of said top compressive layer, said second filament starting above said tensile layer; and,
means for varying the relative position between said laser beam and said heat processed transparent material.

2. A method of laser processing a heat processed transparent material, said heat processed transparent material includes a top compressive layer, a bottom compressive layer, and a tensile layer between said top compressive layer and said bottom compressive layer, as claimed in claim 1, further comprising the steps of:
a control and processing unit operatively coupled to said means for varying said relative position between said laser beam and said heat processed transparent material, wherein said control and processing unit is configured to control said relative position between said laser beam and said transparent material for the formation of an array of continuous laser filaments within said top and bottom compressive layers of said heat processed transparent material.

3. A method of laser processing a heat processed transparent material, said heat processed transparent material includes a top compressive layer, a bottom compressive layer, and a tensile layer between said top compressive layer and said bottom compressive layer, as claimed in claim 1, further comprising the steps of:
forming a crack through said tensile layer without exploding said heat processed transparent material in said top compressive layer, said bottom compressive layer and said tensile layer.

4. A method of laser processing a heat processed transparent material, said heat processed transparent material includes a top compressive layer, a bottom compressive layer, and a tensile layer between said top compressive layer and said bottom compressive layer, as claimed in claim 1 wherein said heat processed transparent material is heat tempered glass.

5. A method of laser processing a heat processed transparent material, said heat processed transparent material includes a top compressive layer, a bottom compressive layer, and a tensile layer between said top compressive layer and said bottom compressive layer, as claimed in claim 1 wherein said heat processed transparent material is heat strengthened glass.

6. A method of laser processing a heat processed transparent material, said heat processed transparent material includes a top compressive layer, a bottom compressive layer, and a tensile layer between said top compressive layer and said bottom compressive layer, as claimed in claim 1 wherein said heat processed transparent material is tempered glass and further comprising the step of forming, naturally, a crack through said tensile layer without exploding said heat tempered glass in said top compressive layer, said bottom compressive layer and said tensile layer.

7. A method of laser processing a heat processed transparent material, said heat processed transparent material includes a top compressive layer, a bottom compressive layer, and a tensile layer between said top compressive layer and said bottom compressive layer, as claimed in claim 1 wherein said heat processed transparent material is heat strengthened glass and further comprising the step of forming, naturally, a crack through said tensile layer without exploding said heat strengthened glass in said top compressive layer, said bottom compressive layer and said tensile layer.

8. A method of laser processing a heat processed transparent material, said heat processed transparent material includes a top compressive layer, a bottom compressive layer, and a tensile layer between said top compressive layer and said bottom compressive layer, as claimed in claim 1 wherein said heat processed transparent material is tempered glass and further comprising the step of forming a crack and cleaving said crack through said tensile layer without exploding said heat processed transparent material in said top compressive layer, said bottom compressive layer and said tensile layer by applying external heat via flame or CO₂ laser heat.

9. A method of laser processing a heat processed transparent material, said heat processed transparent material includes a top compressive layer, a bottom compressive layer, and a tensile layer between said top compressive layer and said bottom compressive layer, as claimed in claim 1 wherein said heat processed transparent material is heat strengthened glass and further comprising the step of forming a crack and cleaving said crack through said tensile layer without exploding said heat processed transparent material in said top compressive layer, said bottom compressive layer and said tensile layer by applying external heat via flame or CO₂ laser heat.

10. A method of laser processing a heat processed transparent material, said heat processed transparent material includes a top compressive layer, a bottom compressive layer, and a tensile layer between said top compressive layer and said bottom compressive layer, as claimed in claim 1 wherein said heat processed transparent material is tempered glass and further comprising the step of forming a crack and cleaving said crack through said tensile layer without exploding said heat processed transparent material in said top compressive layer, said bottom compressive layer and said tensile layer by leaving scribed regions of said heat transparent material in water weakening said scribed regions.

11. A method of laser processing a heat processed transparent material, said heat processed transparent material includes a top compressive layer, a bottom compressive layer, and a tensile layer between said top compressive layer and said bottom compressive layer, as claimed in claim 1 wherein said heat processed transparent material is heat strengthened glass and further comprising the step of forming a crack and cleaving said crack through said tensile layer without exploding said heat processed transparent material in said top compressive layer, said bottom compressive layer and said tensile layer by leaving scribed regions of said heat transparent material in water weakening said scribed regions.

12. A method of laser processing a heat processed transparent material, said heat processed transparent material includes a top compressive layer, a bottom compressive layer, and a tensile layer between said top compressive layer and said bottom compressive layer, as claimed in claim 1 wherein said heat processed transparent material is coated with one of the following selected from the group of metals, organic materials, and insulators.

13. A method of laser processing a sandwich material, said heat processed material includes two sheets and at least one said sheet is heat processed transparent material, said heat processed sheet is coated with metals, organic materials, and semiconductors, and, said heat processed sheet consists of a top compressive layer, a bottom compressive layer, and a tensile layer between said top compressive layer and said bottom compressive layer and wherein arrays of filaments are formed in said top and bottom compressed layers of said heat processed sheet.

14. A method of laser processing a heat processed transparent material, said heat processed transparent material includes a top compressive layer, a bottom compressive layer, and a tensile layer between said top compressive layer and said bottom compressive layer, as claimed in claim 1 wherein said heat processed transparent material is tempered glass and further comprising the steps of forming an array of filaments in said top compressive layer and forming an array of filaments in said bottom compressive layer enabling cleaving of said tempered glass.

15. A method of laser processing a heat processed transparent material, said heat processed transparent material includes a top compressive layer, a bottom compressive layer, and a tensile layer between said top compressive layer and said bottom compressive layer, as claimed in claim 1 wherein said heat processed transparent material is heat strengthened glass and further comprising the steps of forming an array of filaments in said top compressive layer and forming an array of filaments in said bottom compressive layer enabling cleaving of said heat strengthened glass.

16. A method of laser processing a heat processed transparent material, said heat processed transparent material includes a top compressive layer, a bottom compressive layer, and a tensile layer between said top compressive layer and said bottom compressive layer, as claimed in claim 14 and further comprising the step of forming, naturally, a crack through said tensile layer without exploding said heat processed transparent material in said top compressive layer, said bottom compressive layer and said tensile layer.

17. A method of laser processing a heat processed transparent material, said heat processed transparent material includes a top compressive layer, a bottom compressive layer, and a tensile layer between said top compressive layer and said bottom compressive layer, as claimed in claim 15 and further comprising the step of forming, naturally, a crack through said tensile layer without exploding said heat processed transparent material in said top compressive layer, said bottom compressive layer and said tensile layer.

18. A method of laser processing a heat processed transparent material, said heat processed transparent material includes a top compressive layer, a bottom compressive layer, and a tensile layer between said top compressive layer and said bottom compressive layer, as claimed in claim 14 and further comprising the step of forming a crack and cleaving said crack through said tensile layer without exploding said heat processed transparent material in said top compressive layer, said bottom compressive layer and said tensile layer by applying heat to said crack.

19. A method of laser processing a heat processed transparent material, said heat processed transparent material includes a top compressive layer, a bottom compressive layer, and a tensile layer between said top compressive layer and said bottom compressive layer, as claimed in claim 15 and further comprising the steps of forming an array of filaments in said top compressive layer and forming an array of filaments in said bottom compressive layer enabling cleaving of said heat processed glass without exploding said heat processed transparent material in said top compressive layer, said bottom compressive layer and said tensile layer by applying heat to said crack.

20. A method of laser processing a heat processed transparent material, said heat processed transparent material includes a top compressive layer, a bottom compressive layer, and a tensile layer between said top compressive layer and said bottom compressive layer, comprising the steps of:
providing a laser beam, said laser beam includes a burst of ultrafast laser pulses or a single ultrafast laser pulse;
externally focusing said laser beam relative to said heat processed transparent material to form a beam waist at a first location external to said heat processed transparent material and, simultaneously, externally focusing said laser beam relative to said heat processed transparent material to form a beam waist at a second location external to said heat processed transparent material;
said laser pulses or pulse are focused such that a sufficient energy density is maintained within said bottom compressive layer of said heat processed transparent material to form a first continuous laser filament in said bottom compressive layer therein without causing optical breakdown and, said laser pulses or pulse are focused such that a sufficient energy density is maintained with said top compressive layer of said heat processed transparent material to form a second continuous laser filament in said top compressive layer therein without causing optical breakdown;
said first filament is located in said bottom compressive layer and extends to an external surface of said bottom compressive layer, said first filament starting below said tensile layer, and, said second filament is located in said top compressive layer and extends to an external surface of said top compressive layer, and, said second filament starting above said tensile layer; and,
means for varying the relative position between said laser beam and said heat processed transparent material.

21. A method of laser processing a heat processed material, said heat processed transparent material includes a top compressive layer, a bottom compressive layer, and a tensile layer between said top compressive layer and said bottom compressive layer, comprising the steps of:
cutting said top compressive layer;
cutting said bottom compressive layer; and,
said cutting of said top compressive layer and said cutting said bottom compressive layer does not extend into said tensile layer.

22. A product made by the method of claim 1.

23. A product made by the method of claim 20.

24. A product made by the method of claim 21.
